(19) United States
(12) Patent Application Publication
(10) Pub. No.: US 2025/0269285 A1
(43) Pub. Date: Aug. 28, 2025

(54) PROCEDURAL GENERATION AND SOLVABILITY ASSESSMENT OF INTERACTIVE CONTENT

(71) Applicant: Echo Chunk, INC., San Francisco, CA (US)

(72) Inventor: Sami RAMLY, San Francisco, CA (US)

(73) Assignee: Echo Chunk, INC., San Francisco, CA (US)

(21) Appl. No.: 19/060,585

(22) Filed: Feb. 21, 2025

Related U.S. Application Data
(60) Provisional application No. 63/556,468, filed on Feb. 22, 2024.

(51) Int. Cl. A63F 13/67; A63F 13/52; G06T 11/00

(52) U.S. Cl. CPC A63F 13/67; A63F 13/52; G06T 11/00; G06T 2200/24

(57) ABSTRACT

This disclosure provides systems, methods, and devices that generate interactive content using procedural content generation techniques enhanced by machine learning to ensure usability and engagement. In one aspect, a method is provided that includes generating interactive content, such as based on predefined parameters and introducing randomness via a random seed or entropy source. The method further includes extracting features from the interactive content, such as structural, content-specific, statistical, or semantic features. A measure is determined for the interactive content based on the features, and may indicate a predicted likelihood that the content is solvable by a user. The interactive content may then be output based on the measure. Other aspects are also provided.

### TECHNICAL FIELD

The present disclosure relates generally to the field of procedural generation of interactive content, such as content related to video games. More specifically, it pertains to systems and methods for generating and analyzing interactive content for solvability or usability, such as using machine learning techniques.

### BACKGROUND

In the field of interactive digital media, content comprises various elements such as levels, maps, puzzles, scenarios, virtual environments, and dynamic narratives. These elements are integral to providing the interactive experience within digital platforms. The diversity of this content is evident across different genres and formats; for instance, strategy applications typically feature complex puzzles, whereas adventure experiences may offer extensive, exploratory worlds. Interactive storytelling might involve branching narratives that change based on user choices. The generation of interactive content has traditionally been a manual process, conducted within various development platforms or engines. Through this manual methodology, creators craft each component of the experience, from designing levels to scripting interactions, thereby creating a cohesive and engaging environment. This approach allows for detailed and specific content creation, reflecting the creators' intentions and creativity.

Alternatively, automated or procedural content generation (PCG) represents a method where interactive content is generated through algorithms. This method leverages both randomness and a set of predefined rules to autonomously produce diverse content across various media. The adoption of PCG facilitates the generation of new and unique challenges, environments, and scenarios, thus potentially extending the lifespan of an application by providing a non-repetitive experience for users. Furthermore, PCG can enhance the efficiency of the content creation process by reducing the amount of manual labor and time required. By integrating procedural content generation, developers and creators can achieve a greater degree of scalability in content production, contributing to a more dynamic and varied interactive experience.

### SUMMARY

The present techniques relate to systems and methods for procedural generation of interactive content, such as games or gaming environments. These techniques aim to ensure that dynamically created content is solvable or usable by the end-user. This may be achieved by integrating content generation algorithms with predictive models that assess the solvability or usability of the generated content before it is presented to the user. By combining procedural content generation with machine learning predictions, these techniques may filter out unusable or unsolvable content, enhancing user engagement and satisfaction.

In a first aspect, a method includes generating, by a first computing device, interactive content using a procedural content generator; extracting, by the first computing device, first features from the interactive content; determining, by the first computing device, a measure of the interactive content based at least in part on the first features; and outputting, by the first computing device, the interactive content based at least in part on the measure.

In a second aspect according to the first aspect, the interactive content includes digital media configured for user interaction.

In a third aspect according to any one of the first and second aspects, the interactive content includes gaming content, text content, virtual reality content, or any combination thereof.

In a fourth aspect according to any one of the first through third aspects, generating the interactive content includes generating the interactive content based on predefined parameters and introducing randomness via a random seed or entropy source.

In a fifth aspect according to any one of the first through fourth aspects, the first features include at least one of structural features including sizes, shapes, connectivity graphs, or spatial arrangements; content-specific metrics including a number of obstacles, available resources, paths to completion, or difficulty ratings; statistical features including distributions of elements, frequencies of certain patterns, randomness indicators; semantic features including narrative arcs, character interactions, emotional tones, pacing; or a combination thereof.

In a sixth aspect according to the fifth aspect, extracting the first features includes applying a first machine learning model to the interactive content.

In a seventh aspect according to any one of the first through sixth aspects, determining the measure includes determining the measure using a second machine learning model, wherein the measure indicates a likelihood that the interactive content is solvable by a user.

In an eighth aspect according to the seventh aspect, the second machine learning model is trained on historical data including examples of solvable and unsolvable interactive content.

In a ninth aspect according to any one of the first through eighth aspects, the method further includes determining that the measure satisfies a first predefined threshold, and outputting the interactive content in response to determining that the measure satisfies the first predefined threshold.

In a tenth aspect according to the ninth aspect, the method further includes determining a difficulty level based on user interaction data associated with a user, and adjusting the first predefined threshold based on the difficulty level.

In an eleventh aspect according to any one of the first through tenth aspects, the method further includes determining that the measure does not satisfy the first predefined threshold, and refraining from outputting the interactive content in response to determining that the measure does not satisfy the first predefined threshold.

In a twelfth aspect according to any one of the first through eleventh aspects, outputting the interactive content includes transmitting the interactive content to a second computing device associated with a user.

In a thirteenth aspect according to any one of the first through twelfth aspects, the method further includes receiving, by the first computing device, user interaction data associated with the interactive content, and updating the first machine learning model, the second machine learning model, or a combination thereof, based on the user interaction data.

In a fourteenth aspect, a system includes a processor and a memory storing instructions which, when executed by the processor, cause the processor to perform operations including generating interactive content using a procedural content generator; extracting first features from the interactive content; determining a measure of the interactive content based at least in part on the first features; and outputting the interactive content based at least in part on the measure.

In a fifteenth aspect according to the fourteenth aspect, the interactive content includes digital media configured for user interaction.

In a sixteenth aspect according to any one of the fourteenth and fifteenth aspects, the interactive content includes gaming content, text content, virtual reality content, or any combination thereof.

In a seventeenth aspect according to any one of the fourteenth through sixteenth aspects, generating the interactive content includes generating the interactive content based on predefined parameters and introducing randomness via a random seed or entropy source.

In an eighteenth aspect according to any one of the fourteenth through seventeenth aspects, the first features include at least one of structural features including sizes, shapes, connectivity graphs, or spatial arrangements; content-specific metrics including a number of obstacles, available resources, paths to completion, or difficulty ratings; statistical features including distributions of elements, frequencies of certain patterns, randomness indicators; semantic features including narrative arcs, character interactions, emotional tones, pacing; or a combination thereof.

In a nineteenth aspect according to any one of the fourteenth through eighteenth aspects, extracting the first features includes applying a first machine learning model to the interactive content.

In a twentieth aspect, a non-transitory computer-readable medium stores instructions which, when executed by a processor, cause the processor to perform operations including generating interactive content using a procedural content generator; extracting first features from the interactive content; determining a measure of the interactive content based at least in part on the first features; and outputting the interactive content based at least in part on the measure.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 depicts a system for procedurally generating interactive content according to one aspect of the present disclosure.

FIG. 2. depicts a system for procedural content generation and assessment according to one aspect of the present disclosure.

FIG. 3. depicts a system for content generation and assessment according to one aspect of the present disclosure.

FIG. 4 depicts a representation of an encoder-decoder system for game content processing according to one aspect of the present disclosure.

FIG. 5 depicts a method for procedurally generating interactive content according to one aspect of the present disclosure.

FIG. 6 illustrates a computer system according to one aspect of the present disclosure.

### DETAILED DESCRIPTION OF EXAMPLE EMBODIMENTS

Traditional gaming experiences often suffer from a finite set of challenges, leading to potential declines in player engagement. The manual creation of gaming content is resource-intensive and limits the scalability of new and engaging challenges. Moreover, ensuring that this content remains solvable and appropriately challenging adds another layer of complexity. Existing methods lack the dynamic and adaptive qualities needed to continuously supply fresh and solvable gaming content. The described techniques address these issues by introducing an automated system capable of generating new gaming content across various genres and validating its solvability or appropriateness, thus providing an endless stream of content while minimizing human input.

One solution to these problems is the integration of procedural generation techniques with machine learning models for the automatic creation and assessment of gaming content. The procedural generation module ensures the production of a vast array of gaming challenges, varying not only in complexity but also in thematic elements, to maintain player interest. To tackle the crucial challenge of content quality, including solvability and difficulty balance, the system employs machine learning models trained on variables extracted from the gaming content, and the interaction of human users with such content, including signals of solvability and difficulty experienced by users of the procedurally generated content. These models predict the feasibility and appropriateness of challenges, ensuring games remain engaging and accessible. Specific features of the techniques, such as convolutional neural networks (CNNs) for capturing spatial relationships in content and data augmentation techniques for enriching training data, play a significant role in resolving the identified challenges.

In some aspects, the present disclosure provides techniques for generating and assessing diverse gaming content that may be particularly beneficial in enhancing user engagement and satisfaction across a variety of gaming genres. For example, the automation of content creation eases the burden of manual design, increasing efficiency and ensuring a constant flow of novel challenges for players. Machine learning's role in predicting content quality minimizes player frustration associated with unsolvable levels or imbalanced gameplay, thus enhancing the gaming experience. Players benefit from encountering unique challenges in every session, suitable for both beginners and veterans through adaptive difficulty levels. Each session may then be used to further improve the system through the signals generated by the players' interaction with the interactive content. Moreover, these techniques can enhance the computational efficiency of servers running the games by automating content validation processes, thereby reducing workload and potentially lowering operational costs.

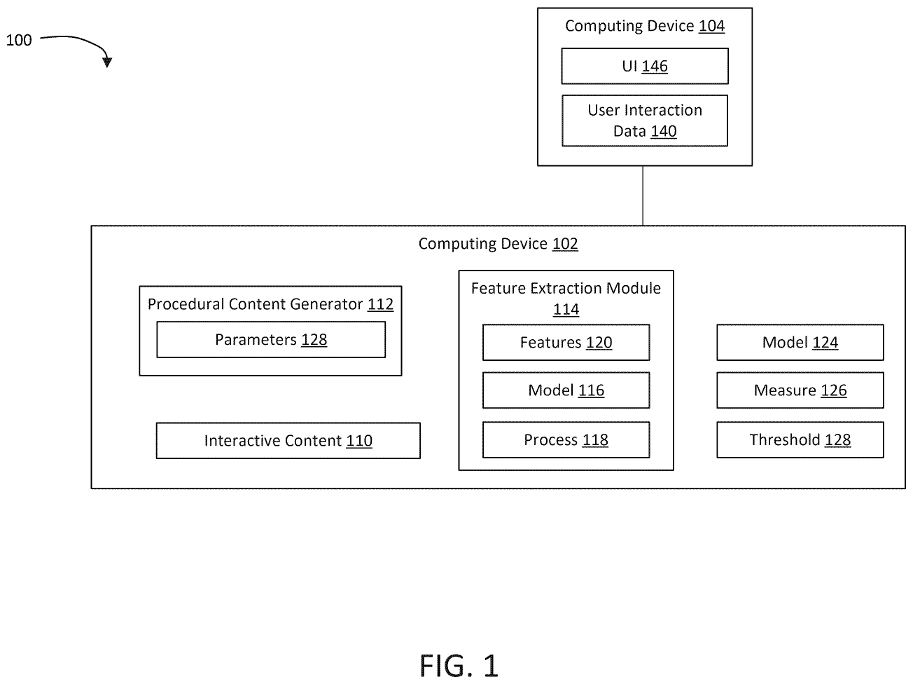

FIG. 1 depicts a system 100 for procedurally generating interactive content according to one aspect of the present disclosure. The system 100 includes a first computing device 102 and a second computing device 104. The first computing device 102 comprises several components, including a procedural content generator 112 for generating interactive content 110, a feature extraction module 114 for extracting features 120 from the interactive content 110, and a model 124 for determining a measure 126 based on the extracted features 120. The second computing device 104 includes a user interface 146 through which a user may interact with the interactive content 110. User interaction data 140 may be collected from the user's interactions via the user interface 146 and used by the first computing device 102 to refine content generation and model training.

The first computing device 102 may be configured to generate interactive content 110 using a procedural content generator 112. The interactive content 110 may include digital media configured for user interaction. In certain instances, users may interact with the interactive content via the first computing device 102 or another, second computing device 104. For example, a user may interact with the interactive content via the user interface 146 on the second computing device 104.

In certain implementations, the interactive content 110 may include gaming content such as puzzles, mazes, levels, maps, grids, encounters, stages, battles, units, cards, quests or combinations thereof within a video game or other interactive application. Users may interact with this gaming content through input devices like keyboards, mice, game controllers, touchscreens, and the like. The gaming content may present challenges that require user input to navigate environments, solve puzzles, or overcome obstacles. For example, the procedural content generator 112 may create procedurally generated dungeon crawler games where levels, enemy placements, and loot are unique in each session. By adjusting difficulty and theme parameters, the procedural content generator 112 creates varied environments that provide endless replayability for users seeking new challenges each time they play.

In certain implementations, the interactive content 110 may involve text content, such as text-based gaming content that includes interactive quests, stories, and/or dialogues where user decisions influence the direction of the narrative. Users may interact with the text content via input methods like controllers, keyboards, or touchscreens. For instance, the procedural content generator 112 may be used within an interactive quest system for a game, where players influence the storyline and outcomes through their choices. The procedural content generator 112 generates narrative branches and character interactions within the game world, ensuring that each experience is unique to the player's decisions. This provides a personalized gaming experience where the outcome of the game can change based on user input.

In certain implementations, the interactive content 110 may provide virtual reality content, offering immersive 3D environments where users can explore and interact using VR headsets and motion controllers. Users may navigate virtual worlds, manipulate objects, or engage in virtual activities. For example, the procedural content generator 112 may create virtual exploration games where landscapes and environments are procedurally generated. The computing device 102 may be configured to construct vast virtual worlds with varied terrain, weather conditions, and ecosystems for users to explore using VR equipment. This allows users to immerse themselves in expansive and diverse environments that offer new experiences with each session.

Generating the interactive content 110 may include using predefined parameters and introducing randomness via a random seed or entropy source to ensure uniqueness and variability. The predefined parameters may include content complexity parameters and thematic parameters.

Content complexity parameters may specify difficulty levels, sizes, or complexity aspects of the interactive content 110. For instance, in gaming content, the difficulty level may determine the number and strength of enemies, the intricacy of puzzles, or the complexity of level layouts. For example, in a chess-based puzzle game, the complexity parameter may adjust the number and arrangement of chess pieces on the board, introduce more advanced pieces, or create more intricate configurations, thereby increasing the difficulty of solving the puzzle. Thematic parameters may specify themes, styles, or narrative elements of the interactive content 110. For example, thematic parameters may include visual themes like fantasy, sci-fi, or historical settings in gaming content. For instance, selecting a “sci-fi” theme may direct the procedural content generator 112 to create game environments featuring advanced technology, alien landscapes, and futuristic storylines, whereas choosing a “fantasy” theme may result in medieval settings with mythical creatures and magic-based gameplay. For text content, thematic parameters may guide the narrative style, such as mystery, adventure, or romance. For example, choosing a “romance” theme may direct the procedural content generator 112 to generate stories centered around emotional relationships, character development, and plotlines involving love interests, providing narratives that align with the romantic genre.

In certain implementations, the first computing device 102 may be configured to introduce randomness, such as through random seeds or entropy sources to ensure that each instance of the interactive content 110 is unique. For instance, the procedural content generator 112 may utilize pseudorandom number generators initialized with random seeds to introduce variability in the generated content. For example, in a maze generation algorithm, different random seeds may result in entirely different maze configurations while adhering to the same complexity and thematic parameters.

As a specific example, when generating a game level, the procedural content generator 112 may use a random seed to determine the placement of obstacles and enemies, ensuring that each playthrough presents a new challenge.

In certain implementations, the computing device 102 may determine content parameters based on historical interactions of one or more other users of related interactive content (e.g., interactive content related to the same game or similar games), historical interactions with the user, or combinations thereof. For instance, historical interaction data 140 may be used by the computing device 102 (e.g., the procedural content generator 112, the model 124, or a combination thereof) to select the appropriate interactive content to be determined and/or output to the user.

In additional or alternative implementations, the procedural content generator 112 may adapt content generation parameters based on user-specified preferences for themes, genres, styles, or a combination thereof. The computing device 102 may receive these preferences from the user via the user interface 146 on the second computing device 104. Users may specify their preferred themes or genres through selection menus, sliders, or input fields. For example, a user might select a “medieval fantasy” theme and a “high difficulty” level for gaming content.

The procedural content generator 112 may process these user preferences by mapping them to specific content generation parameters 128 and adjusting its generation algorithms accordingly. For instance, the computing device 102 may interpret a user's selection of a “medieval fantasy” theme and a “high difficulty” level by selecting appropriate asset libraries (e.g., dragons, castles) and increasing variables related to challenge (e.g., enemy strength, puzzle complexity). The procedural content generator 112 then integrates these adjusted parameters into its generation processes, modifying rules, selecting thematic elements, and augmenting difficulty settings to produce interactive content 110 that aligns with the user's specified preferences.

The procedural content generator 112 may have an overall architecture and operational flow designed to support various content types and generation methods. It may include modules and algorithms specialized for different content creation tasks. For example, for gaming content, the procedural content generator 112 may utilize maze generation processes such as Depth-First Search (DFS), Kruskal's Algorithm, or Prim's Algorithm. Such processes generate mazes or labyrinths by creating a network of interconnected paths and dead-ends. Depth-First Search builds mazes by exploring paths as deep as possible before backtracking, resulting in complex and solvable mazes. Kruskal's Algorithm generates mazes by connecting disjointed sets of cells, ensuring a minimal spanning tree without cycles. Prim's Algorithm starts from a random cell and expands the maze by connecting adjacent cells in a randomized order.

Level design techniques for games may include grammar-based generation, where a set of rules defines how game elements are placed and interact, allowing for consistent yet varied level layouts. For instance, in grammar-based generation, a level might be constructed by defining rules that specify how different rooms connect within a dungeon. The procedural content generator 112 may use these rules to create levels where treasure rooms are always guarded by obstacles, or secret passages connect specific types of chambers, ensuring varied yet coherent layouts. Cellular automata may be used to generate terrain by applying simple rules to grid-based environments, resulting in natural-looking landscapes or cave systems. For example, when using cellular automata to generate terrain, the procedural content generator 112 may start with a grid of randomly assigned cells and apply rules such as “a cell becomes land if at least four neighboring cells are land.” This technique can produce natural-looking islands or cave systems in gaming environments. As another example, the procedural content generator 112 may utilize rule-based systems to generate unique chess puzzles. By applying rules that position pieces in specific patterns or scenarios, such as endgame positions requiring checkmate in a designated number of moves, the generator creates challenging puzzles that test players' strategic skills.

Text generation methods within gaming may involve natural language processing models such as GPT (Generative Pre-trained Transformer) models or rule-based systems that generate textual game content. For example, the procedural content generator 112 may use a GPT model to create dynamic descriptions of new game levels, generate instructions for complex puzzles, or provide detailed specifications for new in-game items or units. This enables the game to offer players customized explanations or hints that enhance understanding and strategy, thereby improving the overall gaming experience.

The procedural content generator 112 may utilize predefined parameters to influence content generation by adjusting input variables, selecting appropriate assets, or modifying generation rules. For example, increasing the difficulty level parameter in a game may result in more enemies or complex puzzles. Changing the thematic parameters may alter visual assets, such as textures and models in gaming content. Random seeds or entropy sources may be incorporated at various stages of the content generation process to introduce unpredictability. For example, in maze generation, random decisions at branching points create diverse maze layouts.

The procedural content generator 112 may utilize various data structures, models, or frameworks in its implementation. For gaming content, data structures like graphs or trees may represent level layouts, with nodes representing rooms or areas and edges representing connections. Tile maps may be used to construct 2D levels, where each tile represents a specific terrain or object.

In natural language processing for text content, models like recurrent neural networks or transformers process sequences of words or tokens, learning contextual relationships to generate coherent text. In virtual reality content, 3D models and environmental data may be managed using scene graphs or spatial partitioning structures to optimize rendering and interaction.

The content generation parameters 128 stored on the first computing device 102 may include default settings, user preferences, and system-defined constraints that guide the procedural content generator 112. These parameters ensure that generated content aligns with desired complexity levels, thematic elements, and user expectations. The procedural content generator 112 may access and modify these parameters during the content generation process, allowing for dynamic adjustments based on real-time inputs or changing conditions, as explained further below.

The first computing device 102 may be configured to extract first features 120 from the interactive content 110. The first features 120 may refer to characteristics or attributes of the interactive content 110 that provide insights into the structure of the interactive content 110, content-specific elements of the interactive content 110, statistical properties of the interactive content 110, semantic meanings of the interactive content 110, and the like.

In particular, the first computing device 102 may include a feature extraction module 114 configured to determine the first features 120. To determine the features 120, the feature extraction module 114 may first receive the interactive content 110 from the procedural content generator 112. Next, the module 114 may perform pre-processing to prepare the content for analysis, which may involve steps like normalization, encoding, or transformation. The feature extraction module 114 may then apply machine learning models, algorithms, or heuristics to extract the first features 120 from the pre-processed content. These extracted features 120 may be stored in designated data structures and then passed on to subsequent modules, such as the model 124, for further analysis. In certain implementations, the feature extraction module 114 may perform this analysis using various techniques tailored to the type of content being processed.

To determine structural features, the feature extraction module 114 may be configured to determine sizes, shapes, connectivity graphs, and spatial arrangements within the interactive content 110. For example, in gaming content such as mazes or levels, the feature extraction module 114 may calculate the dimensions of the environment, including the width and height of a game level or the complexity of a maze's structure. The module 114 may analyze the shape of rooms or corridors and the overall layout of the game environment. Additionally, the feature extraction module 114 may generate connectivity graphs by representing the interactive content 110 as a graph where nodes represent points of interest (e.g., rooms or waypoints) and edges represent connections or pathways between them. Graph algorithms may then be used to analyze connectivity, identify isolated areas, or detect cycles within the content. For virtual reality environments or 3D games, the feature extraction module 114 may assess spatial arrangements by analyzing the positioning of objects, obstacles, and interactive elements in three-dimensional space. Techniques like spatial indexing or collision detection algorithms may be employed to understand how elements are arranged and interact within the virtual environment. As an example, when determining features of content for a chess-based game, the feature extraction module 114 may analyze the positioning of chess pieces on the board to determine structural features. The module 114 may generate connectivity graphs where nodes represent individual squares and edges represent legal moves based on piece types. By analyzing these graphs, the module 114 can identify possible move sequences, potential threats, or defensive structures. This analysis assists in assessing the complexity and solvability of chess puzzles by evaluating spatial relationships and interactions among pieces.

To determine the content-specific metrics, the feature extraction module 114 may be configured to determine quantifiable elements unique to the interactive content 110. For example, the module 114 may be configured to perform tasks such as counting obstacles, assessing available resources, identifying paths to completion, and assigning difficulty ratings. For instance, in a game level, the feature extraction module 114 may identify and tally obstacles like enemies, traps, or barriers, which directly impact the player's experience. It may assess available resources by measuring items like health packs, ammunition, or power-ups that affect the difficulty and solvability of the game. When identifying paths to completion, the feature extraction module 114 may evaluate the number and complexity of routes leading to the game's objectives, considering whether multiple paths exist, the complexity of each path, and any branching narratives or multiple endings. Assigning difficulty ratings may involve calculating a difficulty score based on factors such as enemy strength, puzzle complexity, or time constraints within the interactive content 110. For example, in a chess puzzle, the feature extraction module 114 may count the number of pieces each player has, identify the types of pieces remaining, and assess control over key areas of the board. The module 114 may evaluate available resources by analyzing possible legal moves, potential captures, or checks that can be delivered. When identifying paths to completion, the module 114 may calculate potential move sequences leading to checkmate or draw conditions, contributing to the difficulty rating of the puzzle.

To determine statistical features, the feature extraction module 114 may be configured to analyze the distribution and frequency of elements within the interactive content 110. For example, the module 114 may compute distributions of elements by determining how items like enemy types, power-ups, obstacles, or events are spread throughout the game levels. The module 114 may identify frequencies of patterns by detecting recurring gameplay mechanics, such as the repetition of certain puzzle elements or enemy formations. Additionally, the module 114 may calculate randomness indicators to assess the variability within the content, which may include computing measures of randomness or entropy in item drops, enemy spawn rates, or level layouts. For instance, in a strategy game, the feature extraction module 114 may analyze the frequency and placement of resource nodes to identify dominant strategies or potential imbalances.

To determine semantic features, the feature extraction module 114 may be configured to determine and/or analyze the meaning and context within the interactive content 110. In certain implementations, the module 114 may extract key concepts by identifying the structure of game instructions, objectives, or strategies. For example, the module 114 may analyze descriptions of new weapons or tools to determine their functions and how they integrate with existing gameplay mechanics. In additional or alternative implementations, the module 114 may extract narrative arcs by identifying the structure of stories, including elements like exposition, rising action, climax, and resolution. For example, the module 114 may analyze character interactions by examining relationships and dialogues between characters in stories or games. To determine emotional tones, the feature extraction module 114 may utilize sentiment analysis techniques to gauge the emotional content, such as joy, tension, or sadness. Assessing pacing may involve examining the flow of events or actions over time to evaluate whether the content maintains user engagement. For example, in an interactive narrative game, the feature extraction module 114 may analyze dialogues and plot developments to detect shifts in emotional tone, such as increasing tension or moments of relief. By identifying keywords or phrases associated with specific emotions, the module can assess the pacing and emotional progression of the story, which impacts user engagement.

Each extracted feature contributes to assessing solvability or usability by providing data points that reflect the content's complexity and user engagement factors. Structural features help determine if the content is navigable, content-specific metrics gauge difficulty levels, statistical features reveal consistency or variation, and semantic features ensure the content is meaningful and engaging for the user. For example, in a procedurally generated game level, understanding the complexity of the maze's structure and the placement of obstacles can indicate whether the level is solvable for a typical player. It should be understood that the feature extraction module 114 need not determine all of the features described herein for every instance of interactive content 110. In various implementations, only a subset of features relevant to the specific content type or assessment criteria may be extracted. For example, the feature extraction module 114 may be configured to only determine spatial features for game pieces.

In certain implementations, extracting the first features 120 may involve applying a first machine learning model 116 to the interactive content 110. The first machine learning model 116 may be a neural network designed to process complex data and automatically extract relevant features. The architecture of the first machine learning model 116 may vary depending on the content type; for instance, a convolutional neural network (CNN) may be used for processing image data in gaming content, while a recurrent neural network (RNN), such as a Long Short-Term Memory (LSTM) network, may be employed for sequential data like audio or text.

The first machine learning model 116 may process the interactive content 110 by analyzing input data and learning to identify patterns or features significant for further analysis. For example, a CNN may analyze visual elements by detecting patterns, edges, and shapes to identify objects or environmental features within game levels or virtual environments. An RNN may process sequences of data to capture temporal dependencies, allowing it to identify patterns (e.g., in narrative text).

Training procedures for the first machine learning model 116 may involve using large datasets relevant to the content type. The model may be trained with supervised learning techniques, where input data is paired with known feature labels, enabling the model to learn associations between certain patterns and specific features. Training parameters such as learning rate, batch size, and the number of epochs may be adjusted to optimize performance. Performance metrics like accuracy, loss, precision, or recall may be used to evaluate the effectiveness of the model during and after training.

In certain implementations, extracting the first features 120 may involve applying an algorithmic or heuristic process 118 to the interactive content 110. The feature extraction module 114 may employ specific algorithms or domain-specific heuristics based on expert knowledge. For example, graph traversal algorithms like Depth-First Search (DFS) or Breadth-First Search (BFS) may be used to analyze connectivity in game levels, helping determine if there are accessible paths or isolated areas. Statistical analysis algorithms may compute distributions or measures of randomness, such as calculating standard deviation, variance, or entropy to assess the variability of content elements.

Domain-specific heuristics may involve estimating difficulty by assigning weights to obstacles or challenges based on their perceived impact in gaming content. In narratives, heuristics may identify key plot points by detecting significant word usage frequencies or shifts in sentiment. For instance, in a game, the feature extraction module 114 may calculate the shortest path to completion using pathfinding algorithms, which aids in determining solvability by assessing whether a feasible route exists within the level. For instance, in a chess puzzle, domain-specific heuristics may involve evaluating the control of central squares, the safety of the king, or potential forks and pins. The feature extraction module 114 may calculate metrics such as the mobility of pieces or the balance of material to determine the strategic advantage of a position, aiding in the assessment of solvability. In text content, natural language processing algorithms may parse sentences to extract themes or sentiments, contributing to the semantic analysis.

In certain implementations, extracting the first features 120 may involve applying a pre-trained deep learning model to the interactive content 110 to automatically extract high-level features. The feature extraction module 114 may be configured to utilize transfer learning techniques, where pre-trained models are adapted to specific content types by fine-tuning them with domain-specific data. For instance, pre-trained models like ResNet may be used for image recognition tasks in visual content, or models like BERT may be employed for language understanding tasks in text content. Such pre-trained models can capture complex features such as identifying objects, scenes, or actions in images or video frames and understanding context, themes, or sentiment in written narratives. For example, a pre-trained language model may extract themes of heroism or conflict from a story by analyzing contextual cues and word usage.

The first computing device 102 may be configured to determine a measure 126 of the interactive content 110 based at least in part on the extracted features 120. In certain implementations, the measure 126 may be indicative of the solvability of the interactive content 110, the usability of the interactive content 110, or a combination thereof. For example, the measure 126 may be determined as a solvability score or usability score for the interactive content.

Solvability may refer to the ability of a user to successfully complete or resolve challenges presented by the interactive content 110. Usability may refer to the ease of use and the overall user experience associated with the interactive content 110. For example, in gaming content, solvability may indicate whether a game level is completable given the obstacles and resources available. If a puzzle requires logical reasoning and all necessary clues are present, it is considered solvable. In contrast, usability may pertain to the intuitiveness of game controls and the clarity of visual elements. For instance, a game with straightforward navigation and responsive feedback would have high usability.

In certain implementations, the first computing device 102 may determine the measure 126 by assessing solvability and usability based on the extracted features 120. In certain implementations, the first computing device 102 may utilize a second machine learning model 124 to determine the measure 126. For example, the measure 126 may be calculated by providing the extracted features 120 to the second machine learning model 124. The model 124 may be configured to output a probability value between 0 and 1, where values closer to 1 indicate higher likelihood of the content being solvable or usable. For example, a measure 126 of 0.9 suggests that the interactive content 110 is highly likely to be solvable by users.

In certain implementations, the second machine learning model 124 may be a neural network. The neural network architecture may include multiple layers, such as input layers, hidden layers with activation functions (e.g., ReLU, sigmoid), and an output layer that produces the measure 126. The model may process the extracted features 120 as inputs and learn complex relationships through its layered structure.

In additional or alternative implementations, the second machine learning model 124 may comprise an ensemble of multiple machine learning models to enhance predictive performance. Ensemble methods may include techniques such as bagging (bootstrap aggregating), boosting, or stacking, where predictions from multiple base models—such as decision trees, support vector machines, or neural networks—are combined to produce a final measure for the interactive content 110. For example, the model 124 may utilize a Random Forest algorithm that aggregates the outputs of numerous decision trees trained on different subsets of the data, thereby reducing variance and improving overall accuracy.

Different features may be weighted or prioritized in the assessment based on their perceived impact on solvability or usability. The model may learn these weights during training, assigning higher importance to features that are more predictive of the outcome. For instance, in gaming content, the number of paths to completion may have a significant weight in determining solvability, while visual clarity and control responsiveness may be weighted more heavily for usability. In particular, the second machine learning model 124 may be trained on historical data comprising examples of solvable and unsolvable interactive content 110. This training data may include labeled instances where the outcomes are known, allowing the model to learn patterns and correlations between features and solvability or usability outcomes.

In certain implementations, the computing device 102 may be configured to train the second machine learning model 124. For instance, the computing device 102 may be configured to train the second machine learning model 124 using supervised learning techniques, where the model 124 is updated based on labeled training data by minimizing a loss function that measures the difference between predicted and actual outcomes. The loss function may be, for example, mean squared error for regression tasks or cross-entropy loss for classification tasks. The model's parameters may then adjusted using optimization algorithms such as stochastic gradient descent or Adam optimizer. In certain implementations, the computing device 102 may be configured to train the model 124 using semi-supervised learning techniques, which may combine labeled and unlabeled data (such as to enhance the model's performance when labeled data is limited). In certain implementations, the training datasets may undergo preprocessing steps (which may be performed by the first computing device 102 and/or another computing device), such as normalization of numerical features, encoding of categorical variables, and handling of missing values, to ensure data consistency and improve model training efficiency. Feature selection methods may be applied to reduce dimensionality and focus on the most informative features.

The influence of different features on the measure 126 may vary depending on the content type and the specific characteristics of the interactive content 110. The first computing device 102 may use the model 124 to integrate these features into a cohesive assessment, ensuring that both solvability and usability are adequately considered. In certain implementations, the machine learning model 124 may be configured to combine multiple features from the features 120. For example, logistic regression models may use the sigmoid function to map the linear combination of features to a probability score.

Examples of measures 126 are provided below. For gaming content, a game level with a balanced number of obstacles and resources, clear paths to completion, and moderate difficulty may receive a measure 126 of 0.85, indicating a high likelihood of user success. This suggests that users engaging with this level are expected to successfully navigate and complete the challenges presented. Conversely, challenging content such as an overly complex game level with excessive obstacles and no clear path may receive a measure 126 of 0.2, indicating a low likelihood of user success. This low score suggests that users may find the content frustrating or insurmountable, potentially leading to a negative experience. In such cases, the system 100 may decide to adjust the content or refrain from presenting it to users to maintain a positive engagement level.

In the case of text content, clear and informative text such as well-written instructions for a new game mode, concise descriptions of new gameplay mechanics, or helpful hints for challenging puzzles may receive a usability score of 0.95. This high score reflects the content's strong potential to enhance the player's understanding and enjoyment of the game, where users are likely to feel confident and motivated to engage with new content. Conversely, confusing or overly complex explanations—such as ambiguous rules or inadequate descriptions of how to use a new unit—may receive a measure 126 of 0.2, indicating a low likelihood of user comprehension. This low score suggests that players may find the content frustrating or unintuitive, potentially leading to a negative gaming experience. In such cases, the system 100 may decide to adjust the content or improve the text to maintain positive player engagement.

The first computing device 102 may be configured to output the interactive content 110 based at least in part on the measure 126. In certain implementations, the first computing device 102 may determine that the measure 126 satisfies a first predefined threshold 128 and may output the interactive content 110 based on whether the interactive content 110 satisfies the threshold 128. In particular, the first predefined threshold 128 may define acceptable values for the measure 126, indicating that the interactive content 110 is suitable for user engagement. Satisfying the threshold 128 may involve the measure 126 meeting or exceeding the threshold value when higher values indicate better suitability, or being equal to or less than the threshold value when lower values indicate better suitability, depending on the implementation parameters of the system 100.

Predefined thresholds for the measure 126 solvability or usability scores may be established based on empirical data, industry standards, or desired user experience levels. These thresholds may be adjusted to accommodate different user skill levels or preferences. For example, a solvability score threshold may be set at 0.7 on a scale from 0 to 1, where content scoring 0.7 or higher is deemed appropriate for users.

The criteria and logic used to decide whether to output the interactive content 110 may involve determining whether the measure 126 satisfies the first predefined threshold 128. If the measure 126 satisfies the threshold 128, the content may be considered acceptable, and the first computing device 102 proceeds to output it. For instance, if a generated game level has a solvability score of 0.85, and the threshold is set at 0.7, the score satisfies the threshold, and the content is transmitted to the user. As another example, consider a procedurally generated puzzle game where the model 124 assigns a measure 126 to each level. If a level receives a score of 0.65, which is below the threshold of 0.7, the first computing device 102 may refrain from outputting that level to the user, ensuring that only content likely to provide a satisfactory experience is delivered.

In certain implementations, if the measure 126 does not satisfy the first predefined threshold 128, the first computing device 102 may refrain from outputting the interactive content 110. In additional or alternative implementations, the procedural content generator 112 may adjust the content generation parameters 128—such as difficulty levels or thematic elements—to create new content that may achieve a higher measure 126. Additionally or alternatively, the system 100 may enhance the existing content by simplifying complex sections, adding resources, or improving navigation to increase the measure 126. In further implementations, the first computing device 102 may select alternative content from a pool of generated instances that meet the threshold criteria, ensuring that the interactive content 110 provided to the user is suitable according to the predefined standards.

In certain implementations, the first computing device 102 may determine a difficulty level based on user interaction data 140 associated with a user and adjust the first predefined threshold 128 accordingly. User interaction data 140 may include prior performance metrics, skill levels, completion times, or preferences collected via the user interface 146 on the second computing device 104.

Techniques used to determine a user's difficulty level may involve statistical analysis of performance data, machine learning models that predict skill levels, or heuristic rules based on user behavior patterns. For example, the computing device 102 may calculate an average completion time for previous levels or assess success rates to gauge the user's proficiency.

Thresholds may be adjusted in response to the user's determined difficulty level to tailor the content appropriately. For users exhibiting higher skill levels, the first predefined threshold 128 may be decreased to permit the inclusion of more challenging content (i.e., content with a lower measure 126). Conversely, for users with lower skill levels, the threshold 128 may be increased to ensure that only content that is easier to solve (i.e., content with a higher measure 126) is provided. For example, if a user's interaction data indicates they complete most levels quickly and successfully, the system 100 may adjust the threshold from 0.7 to 0.6, allowing content with lower solvability scores to be included. This dynamic adjustment of content difficulty matches user abilities, enhancing engagement and satisfaction.

The first computing device 102 may be configured to output the interactive content 110 to the user. Outputting may involve presenting the content directly via the first computing device 102, transmitting the content to the second computing device 104 associated with the user, transmitting the content to another computing device, such as a third computing device like a game console or television, or combinations thereof.

In the case where the interactive content 110 comprises gaming content, outputting the content may include presenting it to the user via a user interface 146 on the second computing device 104. The user interface 146 may render the gaming content, enabling user interaction through input devices such as keyboards, mice, touchscreens, or game controllers. For instance, a user operating the second computing device 104, such as a smartphone, may use an application to request a new level in a puzzle game. The request is sent to the first computing device 102, which generates the interactive content 110 using the procedural content generator 112. The feature extraction module 114 extracts features from the content, and the model 124 determines that the measure 126 satisfies the predefined threshold 128. The first computing device 102 then transmits the interactive content 110 back to the user's device. The second computing device 104 receives the content and displays it via the user interface 146, allowing the user to interact with the new game level.

In certain implementations, the first computing device 102 may receive user interaction data 140 associated with the interactive content 110 and update the first machine learning model 116, the second machine learning model 124, or a combination thereof, based on the user interaction data 140. In certain implementations, updating the machine learning models may involve retraining the respective models using the user interaction data 140.

User interaction data 140 may refer to information collected from users as they engage with the interactive content 110, providing insights into user behavior, preferences, and performance. User interaction data 140 may include tracking completion rates, time spent on tasks, choices made during interactive narratives, error rates, feedback ratings, and the like. For example, in a gaming application, the system 100 may collect data on the number of levels completed by a user, the time taken to complete each level, the number of attempts before success, and in-game decisions made by the user.

The collected user interaction data 140 may be used to update and improve the machine learning models. Retraining processes may involve feeding new data into the models to refine their predictive capabilities, with the frequency of retraining varying based on the volume of new data and the need for model accuracy. Methodologies for retraining may include incremental learning, where models are updated with new data while retaining previously learned information, and batch training, where models are retrained from scratch using the entire dataset. Validation techniques such as cross-validation, hold-out validation, or k-fold validation may be employed to evaluate model performance after retraining, ensuring that performance metrics like accuracy, precision, recall, and the like to indicate improvement.

In certain implementations, the system 100 may be configured to generate and evaluate multiple pieces of interactive content before selecting which content to present to the user. In such instances, the first computing device 102 may generate multiple instances of the interactive content 110, determine respective solvability scores 126 for each instance using the second machine learning model 124, and output the multiple instances based at least in part on their respective measures 126. Generating multiple content instances may include varying parameters or introducing randomness during content generation. For example, the procedural content generator 112 may adjust content generation parameters 128, such as difficulty levels, thematic elements, or random seeds, to create diverse versions of content. For instance, in a puzzle game, the system 100 may generate several levels with different layouts, obstacle placements, and challenge types. Solvability scores (e.g., measures 126) may then be calculated for each content instance by passing the extracted features 120 through the second machine learning model 124. Each instance receives a score indicating the likelihood that it is solvable or usable by a user. The multiple instances of interactive content may then be output based on whether their corresponding measures 126 satisfy the threshold 128.

In certain implementations, the first computing device 102 may be configured to augment training data for the second machine learning model 124 by applying data augmentation techniques to existing interactive content instances. Data augmentation involves creating new training samples by transforming existing ones, increasing the diversity and size of the training dataset. Specific data augmentation techniques used may include mirroring, which involves flipping content horizontally or vertically to create new level layouts; rotation, where content elements are rotated by certain degrees to produce variations; synthetic data generation utilizing generative models like Generative Adversarial Networks (GANs) to create new content resembling the original data distribution; and feature manipulation, altering specific features within content instances such as changing colors, textures, or difficulty parameters. For example, in a maze game, mirroring and rotating existing maze layouts can generate new mazes for training without altering the core gameplay mechanics.

In certain implementations, the computing device 102 may be configured to omit one or more of the above-described operations. For example, the computing device 102 may not determine features 120 before determining the measure 126. Instead, the model 124 may be configured to directly receive the interactive content 110 (or a portion thereof) and may determine the measure 126 based on the content 110.

In certain implementations, the computing device 102 may be used to generate and output interactive content 110 for various uses, such as educational tools, personalized media content, interactive storytelling, virtual reality environments, or a combination thereof. For instance, in educational tools, the system 100 may generate adaptive learning modules, practice problems, and quizzes tailored to individual learners' skill levels by assessing performance data and adjusting difficulty accordingly. In personalized media content, the computing device 102 may create customized playlists or media streams that adapt to user preferences and interaction history, utilizing user interaction data to inform content selection and recommendations. In interactive storytelling, the procedural content generator 112 may develop dynamic narratives that change based on user choices and inputs, adjusting the storyline to reflect user decisions while maintaining narrative coherence and character development.

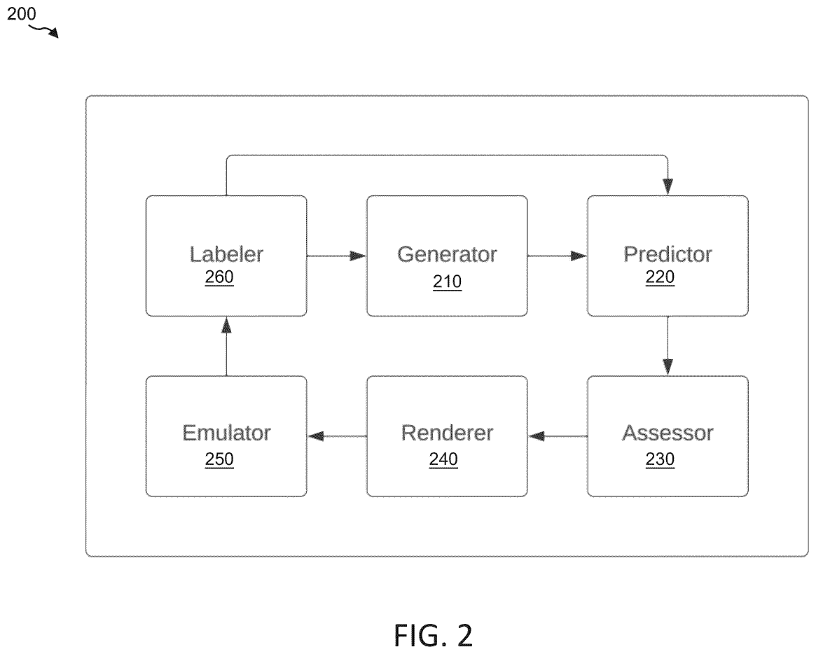

FIG. 2 depicts system 200 for procedural content generation and assessment according to one aspect of the present disclosure. In certain implementations, the system 200 may be implemented at least in part by the system 100. For example, the system 200 may be performed at least in part by the computing device 102. The system 200 includes a generator module 210, a predictor module 220, an assessor module 230, a renderer module 240, an emulator module 250, and a labeler module 260. The modules may be arranged to iteratively generate and evaluate gaming content so that only content meeting particular suitability criteria is ultimately output to a user.

In certain implementations, the generator module 210 may be configured to create new gaming content, such as levels or puzzles, according to parameters that include difficulty settings, thematic elements, randomization seeds, and the like. For example, the generator module 210 may produce a set of terrain layouts or obstacle configurations for a given level. The predictor module 220 may then receive the generated content and may apply machine learning processes to generate probabilistic values indicating whether the content meets quality thresholds, including factors like solvability or complexity. In certain implementations, the predictor module 220 may rely on data from a feature extraction procedure, which may measure features such as the distribution of obstacles or path connectivity within the level.

After the predictor module 220 determines the probabilistic values, the assessor module 230 may determine whether the generated content meets or exceeds certain threshold values. For example, the assessor module 230 may permit content to move forward if a predicted measure of solvability is above a specified level. In certain implementations, the assessor module 230 may request that the generator module 210 create additional variations of a level or puzzle in cases where the results do not meet specified standards. When the Assessor module 230 approves content, the renderer module 240 may convert the content from a raw data form into a format that the emulator module 250 can process, such as a structured game scene.

In certain implementations, the emulator module 250 may provide a simulated environment to confirm that determined content behaves as expected. For example, the emulator module 250 may load a newly generated level to check whether players can navigate from a starting position to a final objective. The emulator module 250 may generate data indicating successful runs, performance metrics, or uncovered issues. The labeler module 260 may record outcomes from the emulator module 250 and may store annotations indicating whether actual gameplay performance aligns with the predicted metrics from the predictor module 220. In certain implementations, the labeler module 260 may then feed the recorded outcomes back to both the generator module 210 and the predictor module 220 so that future content creation and predictions are refined according to the latest empirical data.

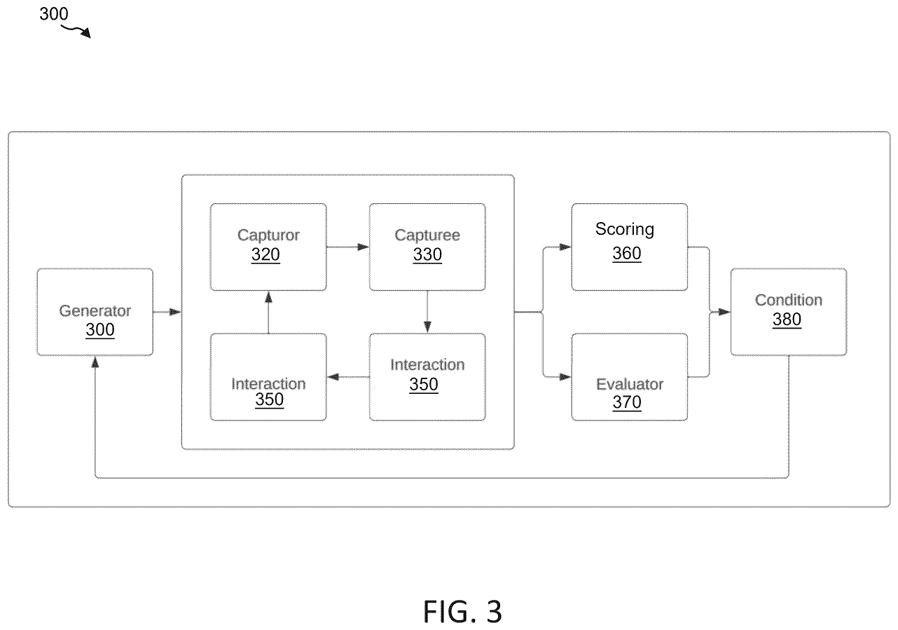

FIG. 3 illustrates a system 300 for content generation and assessment according to one aspect of the present disclosure. In certain implementations, the system 300 may be implemented at least in part by the system 100. For example, the system 300 may be performed at least in part by the computing device 102. In particular, the system 300 may be used to determine content for a chess-based puzzle game. The system 300 includes a capturor module 320, which may correspond to a chess piece that initiates a capture event and a capturee module 330 that corresponds another piece subject to capture. The system 300 also includes a generator module 310, which may produce puzzle configurations or level settings, such as varying initial placements of pieces on a chessboard, and may supply these configurations to the capturor module 320 and the capturee module 330 for potential capture interactions.

The system 300 also includes a ruleset module 340, which may define move limitations or special attributes for pieces within a chess context. For example, the ruleset module 340 may set conditions for how a piece transitions when it captures another piece, such as by altering movement abilities or spatial constraints for the subsequent move. The system 300 further includes an interaction module 350, which may update the board state whenever a capture occurs, such as by marking the captured piece as removed and adjusting accessible squares. In certain implementations, the interaction module 350 may also track auxiliary variables like move counters or special statuses if supported or required by corresponding gaming rules.

After a capture event completes, the capturor module 320 may combine with certain attributes of the capturee module 330, in accordance with the interaction ruleset module 340. For example, a piece might gain new movement patterns when capturing a particular opponent. The system 300 also includes a scoring module 360, which may be configured to examine the resulting board position to determine a score reflecting a position's strategic value or potential for achieving an in-game objective. In certain implementations, the system includes an evaluator module 370, which may be configured to measure how effectively the capture was executed, such as by tracking how many moves were used or how few resources were expended to gain an advantage.

In certain implementations, the system 300 includes a condition module 380, which may be configured to may determine whether a newly produced position is viable for continued gameplay or requires additional refinement. For example, if the scoring module 360 assigns an unexpectedly low score or if the evaluator module 370 flags a high resource cost, the condition module 380 may instruct the generator module 310 to produce a modified configuration, such as adding or rearranging pieces to achieve a more suitable puzzle. In this manner, the system 300 may repeatedly cycle through creation, capture, and evaluation to maintain engaging interactive content.

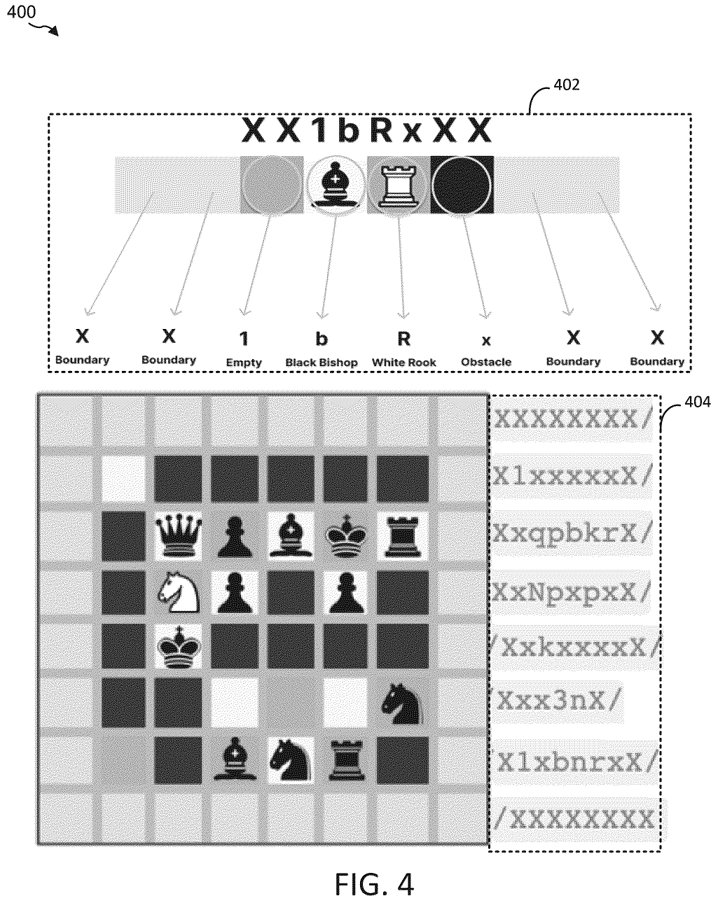

FIG. 4 illustrates a representation 400 of an encoder-decoder system for game content processing according to one aspect of the present disclosure. In certain implementations, the representation 400 may interact with the process of extracting first features 120, as previously discussed in connection with FIG. 1, to ensure that critical structural, positional, and thematic elements of the game state are readily captured and analyzed. The representation 400 may be an example set of features (such as the features 120) that map a game state (for example, a particular chess-inspired puzzle configuration) to a compact text-based encoding for further processing.

To determine the representation 400, the computing device 102 may be configured to utilize an encoder that parses each board cell based on metadata such as boundary markers, empty squares, piece types, or obstacles. For example, this encoder could transform an 8×8 game arrangement where black and white pieces occupy different positions into a string or token array. In certain implementations, each token may correspond to one cell and may contain information identifying whether that cell is empty, contains a rook, a pawn, or another piece, as can be seen in the row 402 and the exemplary encoded strings 404. The resulting encoded string may then serve as a standardized format for future manipulations such as storage, transmission, or generation of variant puzzles.

Once the game state has been placed into the encoded form, an associated decoder module may be used recreate the original configuration by mapping each token back to the appropriate position on a chessboard grid. In certain implementations, the decoder module may verify the consistency of token sequences by referencing a set of rules or constraints. For example, the decoder module may ensure that the number of obstacles or boundary squares matches a prescribed limit, or that the counts of black and white pieces align with the puzzle's difficulty level.

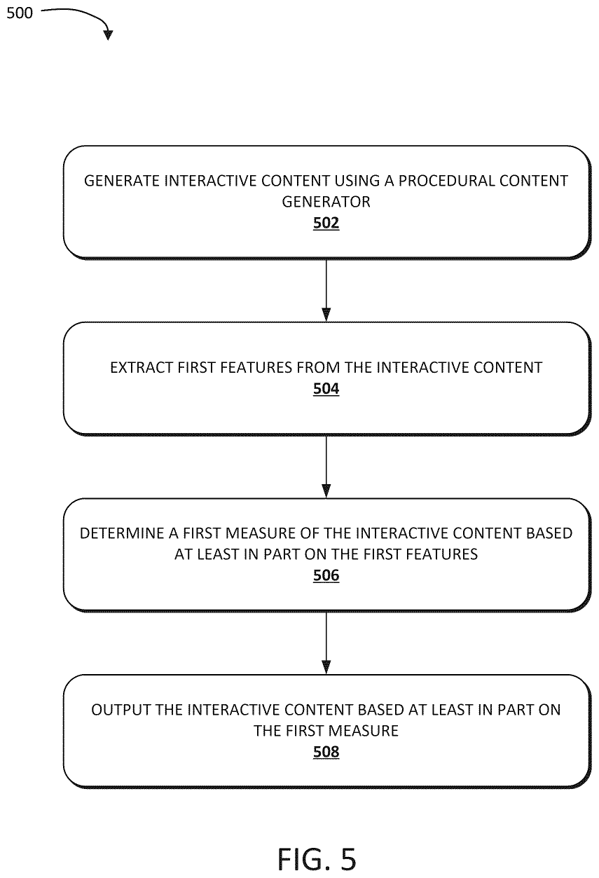

FIG. 5 depicts a method 500 for procedurally generating interactive content according to one aspect of the present disclosure. The method 500 may be implemented on a computer system, such as the system 100. For example, the method 500 may be implemented by the first computing device 102. The method 500 may also be implemented by a set of instructions stored on a computer-readable medium that, when executed by a processor, cause the computing device to perform the method 500. Although the examples below are described with reference to the flowchart illustrated in FIG. 5, many other methods of performing the acts associated with FIG. 5 may be used. For example, the order of some of the blocks may be changed, certain blocks may be combined with other blocks, one or more of the blocks may be repeated, and some of the blocks may be optional.

At block 502, the method 500 includes generating interactive content using a procedural content generator. For example, the first computing device 102 may generate interactive content 110 using a procedural content generator 112. The interactive content 110 may include digital media configured for user interaction. The interactive content 110 may include gaming content, text content, virtual reality content, or any combination thereof. Generating the interactive content 110 may include generating the content based on predefined parameters and introducing randomness via a random seed or entropy source. The predefined parameters may include content complexity parameters, thematic parameters, or a combination thereof. The content complexity parameters may specify difficulty levels, sizes, or complexity aspects of the interactive content 110, and the thematic parameters may specify themes, styles, or narrative elements of the interactive content 110. In certain implementations, generating the interactive content 110 may include adapting content generation parameters based on user-specified preferences for themes, genres, styles, or a combination thereof.

At block 504, the method 500 includes extracting first features from the interactive content. For example, the first computing device 102 may extract first features 120 from the interactive content 110. Extracting the first features may include analyzing structural features, content-specific metrics, statistical features, semantic features, or a combination thereof of the interactive content 110. In certain implementations, extracting the first features may include applying a first machine learning model, such as the first machine learning model 116, to the interactive content 110. The first machine learning model 116 may be a neural network. Alternatively, extracting the first features may include applying an algorithmic or heuristic process to the interactive content 110.

At block 506, the method 500 includes determining a measure of the interactive content based at least in part on the first features. For example, the first computing device 102 may determine a measure of the interactive content 110 based at least in part on the first features 120. Determining the measure may include determining, based at least in part on the first features, an assessment of solvability or usability of the interactive content 110. In certain implementations, determining the measure may include determining a solvability score using a second machine learning model, such as the model 124, wherein the solvability score indicates a likelihood that the interactive content 110 is solvable or usable by a user. Solvability may refer to the probability that a user can successfully complete the interactive content 110, and usability may refer to the degree to which the interactive content 110 facilitates user interaction.

At block 508, the method 500 includes outputting the interactive content based at least in part on the measure. For example, the first computing device 102 may output the interactive content 110 based at least in part on the measure. The method may further include determining that the measure satisfies a first predefined threshold 128 and outputting the interactive content 110 in response to determining that the measure satisfies the first predefined threshold 128. Alternatively, the method 500 may include determining that the measure does not satisfy the first predefined threshold 128 and refraining from outputting the interactive content 110 in response to determining that the measure does not satisfy the first predefined threshold 128. In certain implementations, the method may include determining a difficulty level based on user interaction data 140 associated with a user and adjusting the first predefined threshold 128 based on the difficulty level. Outputting the interactive content 110 may include transmitting the interactive content to a second computing device 104 associated with a user. For example, if the interactive content 110 comprises gaming content, outputting the interactive content may include presenting the gaming content to the user via a user interface 146.

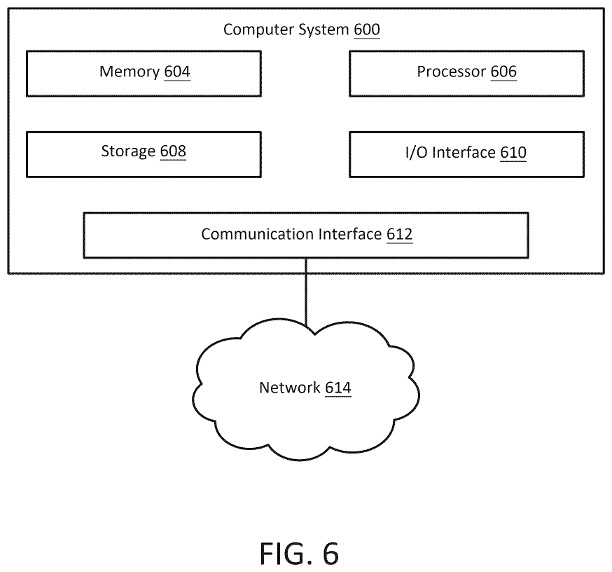

FIG. 6 illustrates an example computer system 600 that may be utilized to implement one or more of the devices and/or components discussed herein, such as the first computing device 102 or the second computing device 104. In particular implementations, one or more computer systems 600 perform one or more steps of one or more methods described or illustrated herein, such as generating interactive content using the procedural content generator 112, extracting features using the feature extraction module 114, determining solvability scores using the model 124, and outputting interactive content based on the solvability scores. In particular implementations, one or more computer systems 600 provide the functionalities of the procedural content generator 112, feature extraction module 114, model 124, user interface 146, or other components of the system 100. In particular implementations, software running on one or more computer systems 600 performs one or more steps of one or more methods described or illustrated herein or provides the functionalities described or illustrated herein. For example, the processor 606 may execute instructions stored in memory 604 to perform data augmentation techniques, train machine learning models, or adjust content complexity based on user interaction data 140. Particular implementations include one or more portions of one or more computer systems 600. Herein, a reference to a computer system may encompass a computing device, and vice versa, where appropriate. Moreover, a reference to a computer system may encompass one or more computer systems, where appropriate.

This disclosure contemplates any suitable number of computer systems 600. This disclosure contemplates the computer system 600 taking any suitable physical form. As example and not by way of limitation, the computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, a gaming console, a virtual reality system, an interactive kiosk, a mainframe, a mesh of computer systems, a server system for cloud-based content generation and processing, a mobile telephone, a personal digital assistant (PDA), a server, a tablet computer system, an augmented/virtual reality device, or a combination of two or more of these. Where appropriate, the computer system 600 may include one or more computer systems 600; be unitary or distributed; span multiple locations; span multiple machines; span multiple data centers; or reside in a cloud, which may include one or more cloud components in one or more networks. For example, the first computing device 102 may be a server in a data center performing content generation and solvability assessment, while the second computing device 104 may be a user's mobile device or gaming console receiving and presenting the interactive content 110. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. For instance, the computer system 600 may generate and validate interactive content 110 in real time as users interact with the system 100, or may process batches of content offline for later use. One or more computer systems 600 may perform at different times or at different locations one or more steps of one or more methods described or illustrated herein, where appropriate.

In particular implementations, computer system 600 includes a processor 606, memory 604, storage 608, an input/output (I/O) interface 610, and a communication interface 612. The computer system 600 may also include a bus 602 that interconnects the aforementioned components. Although this disclosure describes and illustrates a particular computer system having a particular number of particular components in a particular arrangement, this disclosure contemplates any suitable computer system having any suitable number of any suitable components in any suitable arrangement.

In particular implementations, the processor 606 includes hardware for executing instructions, such as those making up a computer program. The processor 606 may execute the procedural content generator 112, feature extraction module 114, model 124, or other software components of the system 100. As an example and not by way of limitation, to execute instructions, the processor 606 may retrieve (or fetch) the instructions from an internal register, an internal cache, memory 604, or storage 608; decode and execute the instructions; and then write one or more results to an internal register, internal cache, memory 604, or storage 608. In particular implementations, the processor 606 may include one or more internal caches for data, instructions, or addresses. This disclosure contemplates the processor 606 including any suitable number of any suitable internal caches, where appropriate. As an example and not by way of limitation, the processor 606 may include one or more instruction caches, one or more data caches, and one or more translation lookaside buffers (TLBs). Instructions in the instruction caches may be copies of instructions in memory 604 or storage 608, and the instruction caches may speed up retrieval of those instructions by the processor 606. Data in the data caches may be copies of data in memory 604 or storage 608 that are to be operated on by computer instructions; the results of previous instructions executed by the processor 606 that are accessible to subsequent instructions or for writing to memory 604 or storage 608; or any other suitable data. The data caches may speed up read or write operations by the processor 606. The TLBs may speed up virtual-address translation for the processor 606. In particular implementations, processor 606 may include one or more internal registers for data, instructions, or addresses. This disclosure contemplates the processor 606 including any suitable number of any suitable internal registers, where appropriate. Where appropriate, the processor 606 may include one or more arithmetic logic units (ALUs), be a multi-core processor, or include one or more processors 606. In certain implementations, the processor 606 may be a graphical processing unit (GPU) or tensor processing unit (TPU) configured to accelerate machine learning computations for training or executing the first machine learning model 116 and the second machine learning model 124. Although this disclosure describes and illustrates a particular processor, this disclosure contemplates any suitable processor.

In particular implementations, the memory 604 includes main memory for storing instructions for the processor 606 to execute or data for processor 606 to operate on. The memory 604 may store software components such as the procedural content generator 112, feature extraction module 114, model 124, and other modules required for generating and processing interactive content 110. The memory 604 may also store data such as the content generation parameters 128, extracted features 120, user interaction data 140, and solvability scores 126. As an example, and not by way of limitation, computer system 600 may load instructions from storage 608 or another source (such as another computer system 600) to the memory 604. The processor 606 may then load the instructions from the memory 604 to an internal register or internal cache. To execute the instructions, the processor 606 may retrieve the instructions from the internal register or internal cache and decode them. During or after execution of the instructions, the processor 606 may write one or more results (which may be intermediate or final results) to the internal register or internal cache. The processor 606 may then write one or more of those results to the memory 604. In particular implementations, the processor 606 executes only instructions in one or more internal registers or internal caches or in memory 604 (as opposed to storage 608 or elsewhere) and operates only on data in one or more internal registers or internal caches or in memory 604 (as opposed to storage 608 or elsewhere). One or more memory buses (which may each include an address bus and a data bus) may couple the processor 606 to the memory 604. The bus may include one or more memory buses, as described in further detail below. In particular implementations, one or more memory management units (MMUs) reside between the processor 606 and memory 604 and facilitate accesses to the memory 604 requested by the processor 606. In particular implementations, the memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory implementations, this disclosure contemplates any suitable memory implementation.

In particular implementations, the storage 608 includes mass storage for data or instructions. The storage 608 may store machine learning models, such as the first machine learning model 116 and the second machine learning model 124, datasets used for training and validation, historical data comprising examples of solvable and unsolvable interactive content, and user interaction data 140. As an example and not by way of limitation, the storage 608 may include a hard disk drive (HDD), a solid-state drive (SSD), or other forms of persistent storage. The storage 608 may include removable or non-removable (or fixed) media, where appropriate. The storage 608 may be internal or external to computer system 600, where appropriate. In particular implementations, the storage 608 is non-volatile, solid-state memory. In particular implementations, the storage 608 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 608 taking any suitable physical form. The storage 608 may include one or more storage control units facilitating communication between processor 606 and storage 608, where appropriate. Where appropriate, the storage 608 may include one or more storages 608. Although this disclosure describes and illustrates particular storage, this disclosure contemplates any suitable storage.

In particular implementations, the I/O Interface 610 includes hardware, software, or both, providing one or more interfaces for communication between computer system 600 and one or more I/O devices. For the second computing device 104, the I/O Interface 610 may interface with user input devices such as keyboards, mice, touchscreens, game controllers, VR motion controllers, or microphones, allowing users to interact with the interactive content 110 via the user interface 146. For the first computing device 102, the I/O Interface 610 may interface with sensors or devices used for data collection or may remain minimal if the device operates as a server. The computer system 600 may include one or more of these I/O devices, where appropriate. One or more of these I/O devices may enable communication between a person (i.e., a user) and computer system 600. As an example and not by way of limitation, an I/O device may include a keyboard, keypad, microphone, monitor, screen, display panel, mouse, printer, scanner, speaker, still camera, stylus, tablet, touch screen, trackball, video camera, another suitable I/O device, or a combination of two or more of these. An I/O device may include one or more sensors. Where appropriate, the I/O Interface 610 may include one or more device or software drivers enabling processor 606 to drive one or more of these I/O devices. The I/O interface 610 may include one or more I/O interfaces 610, where appropriate. Although this disclosure describes and illustrates a particular I/O interface, this disclosure contemplates any suitable I/O interface or combination of I/O interfaces.

In particular implementations, communication interface 612 includes hardware, software, or both providing one or more interfaces for communication (such as, for example, packet-based communication) between computer system 600 and one or more other computer systems 600 or one or more networks 614. For example, the first computing device 102 may use the communication interface 612 to transmit the interactive content 110 to the second computing device 104 over the network 614, which may be the Internet or another suitable network. The communication interface 612 may support protocols and standards required for streaming interactive content, transmitting data securely, and facilitating real-time interactions between devices. As an example and not by way of limitation, communication interface 612 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 614 and any suitable communication interface 612 for the network 614. As an example and not by way of limitation, the network 614 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a Bluetooth® WPAN), a Wi-Fi network, a Wi-MAX network, a cellular telephone network, or any other suitable wireless network or a combination of two or more of these. Computer system 600 may include any suitable communication interface 612 for any of these networks, where appropriate. Communication interface 612 may include one or more communication interfaces 612, where appropriate. Although this disclosure describes and illustrates particular communication interface implementations, this disclosure contemplates any suitable communication interface implementation.

The computer system 600 may also include a bus 602 that interconnects the aforementioned components. The bus 602 may include hardware, software, or both and may communicatively couple the components of the computer system 600 to each other. As an example and not by way of limitation, the bus 602 may include an Accelerated Graphics Port (AGP) or any other graphics bus, a Peripheral Component Interconnect (PCI) bus, a PCI-Express (PCIe) bus, or another suitable bus or a combination of two or more of these buses. The bus 602 may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), solid-state drives (SSDs), or any other suitable computer-readable non-transitory storage media, or any suitable combination of two or more of these, where appropriate. For example, the storage medium may store the machine learning models used by the system 100, including the first machine learning model 116 for feature extraction and the second machine learning model 124 for solvability assessment. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example implementations described or illustrated herein that a person having ordinary skill in the art would comprehend. The scope of this disclosure is not limited to the example implementations described or illustrated herein. Moreover, although this disclosure describes and illustrates respective implementations herein as including particular components, elements, features, functions, operations, or steps, any of these implementations may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular implementations as providing particular advantages, particular implementations may provide none, some, or all of these advantages.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
generating, by a first computing device, interactive content using a procedural content generator;
extracting, by the first computing device, first features from the interactive content;
determining, by the first computing device, a measure of the interactive content based at least in part on the first features; and
outputting, by the first computing device, the interactive content based at least in part on the measure.

2. The method of claim 1, wherein the interactive content comprises digital media configured for user interaction.

3. The method of claim 2, wherein the interactive content comprises gaming content, text content, virtual reality content, or any combination thereof.

4. The method of claim 1, wherein generating the interactive content comprises generating the interactive content based on predefined parameters and introducing randomness via a random seed or entropy source.

5. The method of claim 1, wherein the first features comprise at least one of:
structural features comprising sizes, shapes, connectivity graphs, or spatial arrangements;
content-specific metrics comprising a number of obstacles, available resources, paths to completion, or difficulty ratings;
statistical features comprising distributions of elements, frequencies of certain patterns, randomness indicators; or
semantic features comprising narrative arcs, character interactions, emotional tones, pacing; or a combination thereof.

6. The method of claim 5, wherein extracting the first features comprises applying a first machine learning model to the interactive content.

7. The method of claim 1, wherein determining the measure comprises determining the measure using a second machine learning model, wherein the measure indicates a likelihood that the interactive content is solvable by a user.

8. The method of claim 7, wherein the second machine learning model is trained on historical data comprising examples of solvable and unsolvable interactive content.

9. The method of claim 1, further comprising:
determining that the measure satisfies a first predefined threshold; and
outputting the interactive content in response to determining that the measure satisfies the first predefined threshold.

10. The method of claim 9, further comprising:
determining a difficulty level based on user interaction data associated with a user; and
adjusting the first predefined threshold based on the difficulty level.

11. The method of claim 1, further comprising:
determining that the measure does not satisfy the first predefined threshold; and
refraining from outputting the interactive content in response to determining that the measure does not satisfy the first predefined threshold.

12. The method of claim 1, wherein outputting the interactive content comprises transmitting the interactive content to a second computing device associated with a user.

13. The method of claim 1, further comprising:
receiving, by the first computing device, user interaction data associated with the interactive content; and
updating the first machine learning model, the second machine learning model, or a combination thereof, based on the user interaction data.

14. A system comprising:
a processor; and
a memory storing instructions which, when executed by the processor, cause the processor to perform operations including:
generating interactive content using a procedural content generator;
extracting first features from the interactive content;
determining a measure of the interactive content based at least in part on the first features; and
outputting the interactive content based at least in part on the measure.

15. The system of claim 14, wherein the interactive content comprises digital media configured for user interaction.

16. The system of claim 15, wherein the interactive content comprises gaming content, text content, virtual reality content, or any combination thereof.

17. The system of claim 14, wherein generating the interactive content comprises generating the interactive content based on predefined parameters and introducing randomness via a random seed or entropy source.

18. The system of claim 14, wherein the first features comprise at least one of:
structural features comprising sizes, shapes, connectivity graphs, or spatial arrangements;
content-specific metrics comprising a number of obstacles, available resources, paths to completion, or difficulty ratings;
statistical features comprising distributions of elements, frequencies of certain patterns, randomness indicators; or
semantic features comprising narrative arcs, character interactions, emotional tones, pacing; or
a combination thereof.

19. The system of claim 18, wherein extracting the first features comprises applying a first machine learning model to the interactive content.

20. A non-transitory, computer-readable medium storing instructions which, when executed by a processor, cause the processor to perform operations comprising:
generating interactive content using a procedural content generator;
extracting first features from the interactive content;
determining a measure of the interactive content based at least in part on the first features; and
outputting the interactive content based at least in part on the measure.
